(19) United States
(12) Patent Application Publication
(10) Pub. No.: US 2024/0212522 A1
(43) Pub. Date: Jun. 27, 2024

(54) HAPTIC READING DEVICE IMPLEMENTING THE BRAILLE-PERKINS METHOD

(71) Applicant: COMMISSARIAT À L'ÉNERGIE ATOMIQUE ET AUX ÉNERGIES ALTERNATIVES, Paris (FR)

(72) Inventors: Lucie Pantera, GIF-SUR-YVETTE CEDEX (FR); Charles Hudin, GIF-SUR-YVETTE CEDEX (FR); Sabrina Panëels, GIF-SUR-YVETTE CEDEX (FR)

(21) Appl. No.: 18/557,397

(22) PCT Filed: Apr. 28, 2022
(86) PCT No.: PCT/FR2022/050816

§ 371 Date: Oct. 26, 2023

(30) Foreign Application Priority Data
Apr. 28, 2021 (FR) FR2104426

(51) Int. Cl. G09B 21/00

(52) U.S. Cl. CPC G09B 21/004

(57) ABSTRACT

A haptic device for reading using the Braille-Perkins method includes a plate provided with a surface with which the index finger, the middle finger and the ring finger of each hand of the user are intended to come into contact, actuators fastened to the plate, a control unit for controlling the actuators and computing the control signals implementing an inverse filtering operation, and configured to send control signals to the actuators, the control unit being configured to make n areas of the surface vibrate, n being an integer between 1 and 6, to stimulate the index finger, the middle finger and the ring finger of each hand of the user and reproduce by haptic stimulation the Braille characters using the Braille-Perkins method, each area corresponding to a dot of a Braille character.

### TECHNICAL FIELD AND PRIOR ART

The present invention relates to a haptic reading device implementing the Braille-Perkins method, more particularly a haptic reading device implementing the Braille-Perkins method using the inverse filtering method.

Visually-impaired people can read text that has been translated into the Braille alphabet, in which each character is represented in a six-dot matrix in two columns, with each character formed by one to six raised dots. Access to digital content using the Braille alphabet requires the use of a Braille display which is a heavy, bulky, fragile and expensive object. This range cannot be transported like a smartphone-type mobile phone.

There is a writing machine, called the Perkins machine, which allows writing a text in Braille. It consists of a typewriter with six keys, each key corresponding to a dot of a Braille character. The user places the index finger, the middle finger and the ring finger of each hand on a key. The index finger of the left hand corresponds to the dot 1, the middle finger of the left hand corresponds to the dot 2, the ring finger of the left hand corresponds to the dot 3, the index finger of the right hand corresponds to the dot 4, the middle finger of the right hand corresponds to the dot 5, the ring finger of the right hand corresponds to the dot 6.

This writing method will be referred to as the Braille-Perkins method. This method is applied to reading, which consists in using the index finger, the middle finger and the ring finger of each hand.

There are touch surface type devices that send stimulations to the index finger, the middle finger and the ring finger of each hand, however the problem of locating the vibrations arises. Indeed, the activation of an actuator in order to stimulate one of the fingers could make the neighbouring areas of this finger vibrate and also solicit one or more of the other fingers and therefore transmit false information to the reader.

The document Nicolau, H. M. “Holibraille: Multipoint vibrotactile feedback on mobile devices’. Proceedings of the 12th Web for All Conference, 1-4 May, 18-20, 2015 describes a device including a rectangular case to which six actuators are fastened via springs. Three actuators are arranged in a column along a first edge of the case and three actuators are arranged in a column along a second edge of the case parallel to the first edge. Each actuator represents a dot of the Braille matrix. The user places his/her fingers directly in contact with the actuators. The use of springs to connect the actuators to the case allows locating the vibrations and avoids transmission of vibrations from one actuator to a finger other than that in direct contact with the vibrating actuator. Reading of the character is then possible. This device is bulky and fragile; the actuators projecting from the case.

The document Rantala, J. R. “Methods for presenting braille characters on a mobile device with a touchscreen and tactile feedback”, IEEE Transactions on Haptics, 28-39; Jan. 15, 2009 describes a mobile device allowing reading Braille characters by tactile feedback. The device includes a screen under which a piezoelectric actuator is fastened which makes the entire screen vibrate. The user detects the vibration directly with his/her finger or a stylus. Haptic feedback cannot be located on the screen. Reading a character could be done only dot-by-dot.

### DISCLOSURE OF THE INVENTION

Consequently, the present invention aims to offer a haptic device implementing the Braille-Perkins method that is simple and comfortable to use and limits the risks of misinterpretations of the signals by the user.

The aim set out hereinabove is achieved by a haptic device including a plate provided with a surface with which the fingers of the user will come into contact, actuators fastened to the plate, said actuators being capable of generating a vibration at the surface in distinct areas, means for controlling said actuators, comprising means for computing the control signals implementing an inverse filtering operation, and sending control signals to the actuators. The control means are configured to make between one and six areas of the surface vibrate to enable at least the haptic display of Braille characters using the Braille-Perkins method.

The use of inverse filtering to compute the control signals of the actuators allows compensating for the effects of wave propagation outside the area(s) over which the fingers are placed, which avoids the fingers being wrongly stimulated, which would distort the reading. In particular, the fingers intended to be stimulated may be close, for example the index finger and the middle finger or the middle finger and the ring finger of one hand. Thanks to the invention, the vibrations emitted beneath the middle finger will not be felt by the index finger or the ring finger.

The stimulations reproducing each dot of a Braille character may be simultaneous, successive or grouped in pairs or more.

Advantageously, a large number of actuators is used to be able to best generate vibrations in all areas of the surface. Thus, the user can place his/her fingers freely over the surface without this affecting reading. Preferably, an interpolation method is implemented to compute the responses in the areas between the actuators.

Preferably, a prior step of detecting the location of the fingers on the surface is implemented to locate where the index finger, the middle finger and the ring finger of each hand are located.

Quite advantageously, the haptic device is also adapted to enable text entry. For this purpose, the device includes means for detecting the force exerted by each of the fingers. Quite advantageously, the force detection means may measure the intensity of the force, thus the user could permanently leave his/her fingers over the surface and modulate the pressure of his/her fingers over the latter to enter a text. In a preferred example, the actuators actually form the force detection means.

The present invention may be integrated into mobile devices such as mobile phones such as smartphones or tablets but also into home automation devices, for example cooktops and other household appliances.

The object of the present application is a haptic device for reading using the Braille-Perkins method including a plate provided with a surface with which at least the index finger, the middle finger and the ring finger of each hand of the user are intended to come into contact, actuators fastened to the plate opposite said surface, said actuators being capable of generating a vibration at the surface in distinct areas, a control unit for controlling said actuators, comprising means for computing the control signals implementing an inverse filtering operation, and configured to send control signals to the actuators, the control unit being configured to make n areas of the surface vibrate, n being an integer comprised between 1 and 6, to stimulate the index finger, the middle finger and the ring finger of each hand of the user and reproduce by haptic stimulation the Braille characters using the Braille-Perkins method, each area corresponding to a dot of a Braille character.

In one embodiment, the control unit is configured to make the n areas vibrate simultaneously.

In another embodiment, the control unit is configured to make the n areas vibrate successively.

Advantageously, the device includes means for detecting the presence of the index finger, the middle finger and the ring finger of each hand of the user and wherein the control unit is configured to locate the position of the index finger, the middle finger and the ring finger of each hand of the user on the surface and record said positions.

For example, the detection means include means for measuring the pressure exerted by each finger on the surface.

The haptic reading device may include means for controlling the display of the characters on the surface.

Another object of the present application is a haptic device for displaying and entering Braille characters using the Braille-Perkins method including a haptic reading device according to the invention, wherein the control unit is also configured to translate a measurement of the pressure exerted for each finger at a dot of a Braille character and to identify the Braille character.

Another object of the present application is a method for operating a haptic device for reading digital content given by a user according to the invention, including:
a) placing at least the index finger, the middle finger and the ring finger of each hand of the user on the surface of the device,
b) translating the digital content into Braille characters,
c) generating for each Braille character signals to the actuators so they make n areas of the surface vibrate, said areas being covered by the index finger, the middle finger and the ring finger of each hand of the user.

Advantageously, the operating method includes, between step a) and step b), a step of locating the location of the index finger, the middle finger and the ring finger of each hand of the user on the surface and of associating each of these fingers with said location.

Another object of the present application is a method for operating a haptic device for displaying and entering Braille characters using the Braille-Perkins method according to the invention, implementing the steps of the operating method according to the invention, and including:
measuring the pressure exerted by the index finger, the middle finger and the ring finger of each hand,
comparing with a threshold value,
translating the measurements into a dot of a Braille character and identifying the Braille character.

### BRIEF DESCRIPTION OF THE DRAWINGS

The present invention will be better understood based on the following description and appended drawings wherein:

FIG. 1 is a schematic illustration of an example of a haptic device according to the present invention.

FIG. 2 is a schematic illustration of a side view of the haptic device of FIG. 1.

FIG. 3A is a transcription of the letter d in Braille.

FIG. 3B shows the device of FIG. 1 during the haptic display of the letter d according to a first operating mode.

FIG. 3C is a graphical illustration of the amplitude of the vibrations over time at the areas Z1 to Z6 to haptically display the letter d in the first operating mode.

FIG. 4 is a graphical illustration of the amplitude of vibrations over time at the areas Z1 to Z6 to haptically display the letter d in a second operating mode; and

FIG. 5 is a graphical illustration of the amplitude of vibrations over time at the areas Z1 to Z6 to haptically display the letter d in a third operating mode.

### DETAILED DISCLOSURE OF PARTICULAR EMBODIMENTS

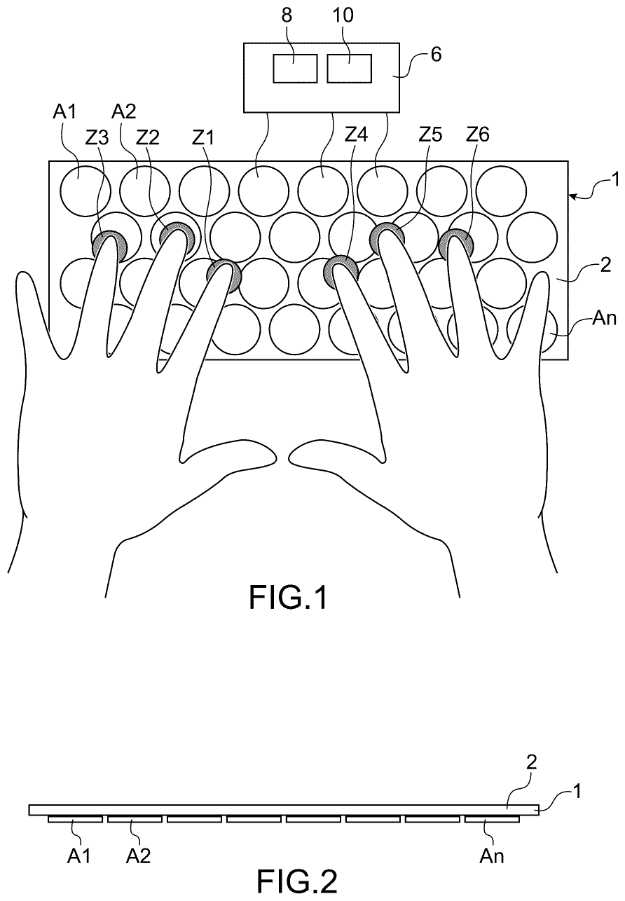

In FIG. 1, one could see a schematic illustration of a top view of a haptic device according to the invention, including a plate 1, bearing on one of its faces the surface for interaction with the outside, referred to as touch surface 2, a plurality of actuators A1, A2 . . . An arranged beneath the plate 1, for example fastened on the surface of the plate 1 opposite to the touch surface 2. The haptic device also includes a control unit 6 for controlling each of the actuators comprising means 8 for computing the control signals.

The material of the plate is selected such that it enables low frequency vibrations, typically lower than 1,000 Hz, preferably between 150 Hz and 1,000 Hz which is the touch sensitivity frequency band, to propagate over a few centimetres (cm). The material may be a flexible or rigid material, for example glass.

The actuators are such that they are capable, when activated, of exerting a force on the plate in an out-of-plane direction, i.e. orthogonal to the plane of the plate. The plane of the plate is the plane extending parallel to its largest surface. In FIG. 2, one could see an example of a side view of the interface of FIG. 1. The actuators are capable of exerting a force upwards and/or downwards in the illustration of FIG. 2.

The actuators may be in direct contact with the plate.

For example, the actuators are piezoelectric actuators. This actuator type is commonly implemented in tactile interfaces. A piezoelectric actuator includes a piezoelectric material in the form of a plate, for example PZT (Lead Titanium Zirconate) or AlN (Aluminium Nitride), and electrodes on either side of the plate and in contact with the latter, to apply a current thereto causing the deformation of the piezoelectric material.

Thanks to the invention, it is also possible to impart a controlled profile to the surface. Indeed, a permanent deformation of the surface may be viewed as a zero frequency vibration. Hence, it is possible to apply the inverse filter process. By exerting a localised force on a plate, the entire surface is deformed. By applying the inverse filter process, it is possible to cancel this deformation at the desired points.

Electromagnetic actuators may be considered. They are suited to low frequency operation. For example, such actuators are described in the document Benali-Khoudja et al.—2007—VITAL An electromagnetic integrated tactile display”. For example, each of the actuators includes a fixed coil and a magnet bonded beneath the touch surface. The current signal sent in the coils is computed by inverse filtering.

The user is intended to interact with the touch surface 2, in particular by placing the index finger, the middle finger and the ring finger of each hand on the touch surface and feeling vibrations at one or more of these fingers.

The fingers may be arranged directly or not directly over the actuators A1 to An.

For example, the actuators have a disc-like shape with a diameter Ø comprised between 20 mm and 35 mm. Alternatively, they may have the shape of a hexagon which approximates the shape of a disc, ensuring maximum paving beneath the touch surface.

Preferably, the device implements a large number of actuators beneath the entire interaction surface, which allows improving the near-field control of the device. The potential stimulation areas are located in the near-field of the actuators, i.e. the potential stimulation areas are located at a distance smaller than or equal to the dimension of the actuators in the plane or to the wavelength of the control signals sent to the actuators, the largest distance being considered.

This near-field configuration allows for an effective control by reducing the power of the signals emitted to obtain given movements, in particular when the control points are less than one wavelength apart from each other.

The actuators may be fastened, for example by gluing directly onto the face of the plate 1 opposite to the touch surface 2. The actuators are independent. Alternatively, the actuators include in common a layer of piezoelectric material, a common electrode between the piezoelectric layer and the plate and electrodes over the opposite face of the piezoelectric layer so as to make individual actuators.

The computing means 8 implement an inverse filtering operation to determine the control signals. The computing means also implement a vibration synthesis algorithm determining the desired signal in an area, according to the desired stimulation in this area, and taking into account for example the pressing force on this area. This type of algorithm is well known to a person skilled in the art and will not be described in detail.

For example, the inverse filtering operation is described in the article “Optimal focusing by spatio-temporal inverse filter. I. Basic principles” M. Tanter et al., The Journal of the Acoustical Society of America 110, 37 (2001) applied to image processing in medical imaging. An example of implementation of the inverse filtering operation for determining the control signals of actuators of a surface device is described in the document WO2021922762 and in the article Lucie Pantera and Charles Hudin, “Multitouch Vobrotactile Feedback on a Tactile Screen by the Inverse Filter Technique: Vibration Amplitude ans Spatial Resolution” in Transactions on Haptics—Special issue on surface haptics, pp 1-11 2020.

The response R of a linear system to an excitation E is given by the relationship R=H·E, with H the transfer function of the system. In the application to a tactile interface, we observe the movement Uᵢ of the plate measured at a point i, for example at the centre of an actuator, in response to a signal Sⱼ sent to an actuator j. Hence, we have:

$${U}_{i} ( ω ) = {H}_{ij} ( ω ) {S}_{j} ( ω )$$

With Hᵢⱼ(ω) the transfer function between the signal sent to actuator j and the movement recorded at the point i. If N actuators transmit simultaneously, the obtained movement is the sum of the contributions of these N actuators, i.e.:

$${U}_{i} ( ω ) = {\sum }_{j = 1}^{N} {H}_{ij} ( ω ) {S}_{j} ( ω )$$

In a matrix form in the case of M control points i, we write:

$${[ \begin{matrix}{U}_{1} \\ {U}_{2} \\ ⋮ \\ {U}_{M}\end{matrix} ]}_{ω} = {[ \begin{matrix}{H}_{11} & {H}_{12} & … & {H}_{1 N} \\ {H}_{21} & {H}_{22} & & {H}_{2 N} \\ ⋮ & & ⋱ & ⋮ \\ {H}_{M 1} & {H}_{M 2} & … & {H}_{MN}\end{matrix} ]}_{ω} \cdot {[ \begin{matrix}{S}_{1} \\ {S}_{2} \\ ⋮ \\ {S}_{N}\end{matrix} ]}_{ω} \\ Or \\ {𝕌}_{ω} = {ℍ}_{ω} . {𝕊}_{ω}$$

Hence, the movement uᵢ at the control point i depends on all of the signals sent to all of the actuators. Hence, all actuators participate in the movement at each control point i. Hence, the movement uᵢ is not proportional to the signal sᵢ which is applied thereto, but depends, via the terms Hᵢⱼ on the signals sent to the other actuators which produce waves propagating throughout the plate.

The inverse filtering consists in inverting this relationship by calculating the signal to be applied to all actuators to obtain the desired movement. By denoting

$${𝕍}_{ω} = {[ \begin{matrix}{V}_{1} \\ {V}_{2} \\ ⋮ \\ {V}_{M}\end{matrix} ]}_{ω}$$

the desired movement, in the frequency domain, at all positions, the signal

$${𝕊}_{ω} = {[ \begin{matrix}{S}_{1} \\ {S}_{2} \\ ⋮ \\ {S}_{N}\end{matrix} ]}_{ω}$$

to be sent to each of the actuators is computed by the relationship:

$${𝕊}_{ω} = {ℍ}_{ω}^{- 1} . {𝕍}_{ω}$$

Finally, a movement [symbol] _{ω} is obtained given by:

$${𝕌}_{ω} = {ℍ}_{ω} . {𝕊}_{ω} = {ℍ}_{ω} . {ℍ}_{ω}^{- 1} . {𝕍}_{ω} = {𝕍}_{ω}$$

Thus, a movement in compliance with the expected one is obtained:

$${𝕌}_{ω} = {𝕍}_{ω} .$$

By inverting the matrix, all effects are compensated, before generating the control signals to obtain the desired movement despite distortions, reverberations and wave propagations. The determination of the matrix is performed during a calibration phase during which the vibrations in the areas above each of the actuators caused by the actuation of the actuators are measured, as well as the propagation, reverberation and attenuation of waves in these areas.

This filter is temporal to the extent that it performs a transformation on the amplitude and the phase at all frequencies, and spatial since it takes into account the signals emitted by all actuators.

Thanks to the inverse filtering operation, control signals are sent to all actuators and are such that, for the areas for which no stimulation is desired, the actuators generate vibrations intended to cancel those resulting by propagation of the activation of the actuator beneath the area(s) where it is desired to generate a stimulation.

The computation of the control signal of the actuator beneath the area where a stimulation is to be generated takes into account both the desired movement and the effect of the propagation and reflection of the vibrations produced by the other actuators. According to the invention, each actuator is therefore controlled while taking into account the external environment.

It is then possible to obtain, in each area of the surface, a movement which may be zero, corrected for distortion and reverberation effects, and independent of the movements at the centre of the other areas.

According to one operating mode of the invention, the computing means are configured to simultaneously generate in at most six locations vibrations intended to stimulate the index finger, the middle finger and the ring finger of each hand, these locations not being able to be defined before placing the fingers over the touch surface.

The application of the inverse filtering method to generate control signals to the actuators allows locating the generated vibrations quite accurately and thus avoiding, for example, stimulating both the middle finger and the ring finger of the left hand while only the middle finger should be excited. All actuators receive an activation signal to at least partially compensate for distortion, reverberation and wave propagation outside the areas covered by the index finger, the middle finger and the ring finger of both hands.

Furthermore, advantageously, in order to be able to generate vibrations at any point of the surface and therefore make placing the fingers over the touch surface even freer, an interpolation step is carried out allowing theoretically computing the impulse response at each point of the surface. As indicated hereinabove, a surface calibration step is carried out where the impulse responses of the surface are recorded in a matrix ĥ_{cq}(t) where c=1 . . . C, with C the number of calibration points selected for calibration and q the number of actuators. Starting from this matrix ĥ_{cq}(t) and the abscissa x_{f} and ordinate y_{f} coordinates of the finger(s) on the screen, it is possible to compute the matrix h_{fq}(t) corresponding accurately to the location of the finger(s) which allows for faster and more accurate computations. To obtain the matrix h_{fq}(t), a Fourier interpolation as hereinbelow is carried out:

$${h}_{fq} ( t ) = {\sum }_{c = 1}^{C} {\hat{h}}_{eq} ( t ) . sin c ( \frac{π ( {x}_{f} - {x}_{c} )}{dx} ) . sin c ( \frac{π ( {y}_{f} - {y}_{c} )}{dy} )$$

Where:
sinc(x)=sin(x)/x: The cardinal sine function,
x_{f}: The coordinates of the finger/fingers on the x axis,
y_{f}: The coordinates of the finger/fingers on the y axis,
x_{c}: The coordinates of the calibration points on the x axis,
y_{c}: The coordinates of the calibration points on the y axis,
ĥ_{cq}: The impulse response measured at the calibration points.

The haptic device also includes means 10 for detecting the presence of fingers over the touch surface. For example, it may consist of capacitive, resistive or infrared means, these means are well known to a person skilled in the art and will not be described in detail in this application. For example, the device includes a capacitive screen. A local variation in the capacitance corresponds to a pressure exerted by a finger and therefore to the presence of a finger.

Advantageously, the control unit 6 is configured to launch at the beginning of use of the haptic device a step of locating the fingers over the touch surface 2, more particularly locating the location of the index finger, the middle finger and the ring finger of each hand and associate the areas Z1 to Z6 of the touch surface 2 with them. Thus, the positions of the six fingers will be known and the vibrations to reproduce the letters using the Braille-Perkins method could be generated in the areas detected and associated with the index finger, the middle finger and the ring finger of each hand. The implementation of such identification means enables the user to hold the haptic device without having to impose an orientation of the device.

The interface allows working at all frequencies and not only at touch sensitivity frequencies comprised between 150 Hz and 1,000 Hz, however these are advantageous because they produce no sound upon activation of the actuators. Thus, different types of actuators may be used. Piezoelectric actuators are suited for high and low frequency operations.

An example of “handling” of the haptic device will now be described. For example, the haptic device is integrated into a mobile phone, such as a smartphone. The user sets his/her smartphone in the “Braille Entry” mode, then positions it horizontally and starts a calibration phase. For example, he/she starts by making a quick and simultaneous tap with the index finger, the middle finger and the ring finger of the left hand then of the right hand. The six fingers are then calibrated on the screen. The control unit “knows” where the index finger, the middle finger and the ring finger of each hand are located on the screen and can then send the signals to these locations to “display” the letters by touch.

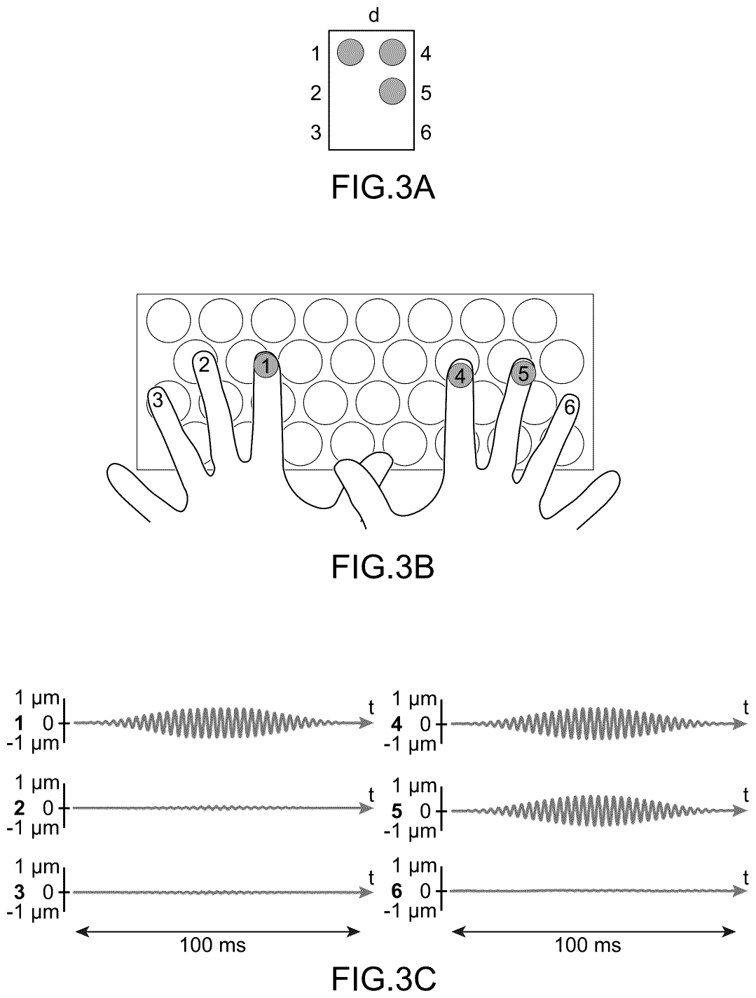

An example of operation of this device will now be described with reference to FIGS. 3A to 3C.

It is desired to display the d by touch on the touch surface 2.

In FIG. 3A, one could see the transcription of d in Braille. For this purpose, the index finger of the left hand (dot 1), the index finger of the right hand (dot 4) and the middle finger of the right hand (dot 5) should be stimulated.

In FIG. 3B, one could see the index finger, the middle finger and the ring finger of each hand of the user on the touch surface 2.

The control unit 6 detects the presence of the fingers and launches a finger location step in order to associate with each area Z1, Z2, Z3, Z4, Z5, Z6 covered by each finger a finger and therefore a location in the three-row two-column matrix of a Braille character.

For example, at the end of the location step, the control unit 6 has associated the area Z1 with the index finger of the left hand, the area Z2 with the middle finger of the left hand, the area Z3 with the ring finger of the left hand, area Z4 with the index finger of the right hand, the area Z5 on the middle finger of the right hand and the area Z6 on the ring finger of the right hand.

It may be provided to repeat this location step if the device detects that the user has removed all or part of his fingers off the surface for a period of time and therefore that the location of all or part of the fingers on the surface has changed.

Afterwards, the control unit plays the d letter. The control means will calculate for each finger the signals to be sent to each actuator to generate a tactile stimulation in the areas Z1, Z4 and Z5. For the letter d, the index finger of the left hand, the index finger of the right hand and the middle finger of the right hand are stimulated.

In FIG. 3C, one could graphically see the amplitude of the vibrations over time at the areas Z1, Z4 and Z5. Thanks to the implementation of the inverse filtering method, the vibrations are localised and the areas Z2, Z3 and Z6 are stationary. In this example, the amplitude of the vibrations and the duration of a stimulation are high enough to be felt by the user. For example, the vibration amplitude could reach 4 μm. In the illustrated example, the amplitude of the vibrations is in the range of 1 μm. The duration of the stimulation is long enough to be perceived by a user, for example it is comprised between 200 ms and 500 ms.

Thanks to the application of the inverse filtering method, only the fingers to be stimulated actually feel a stimulation and the fingers are not stimulated by error since the propagations and reverberations of the waves are avoided or at least substantially limited.

Quite advantageously, the haptic device includes means to enable the user to act on the display of the letters. For example, means are provided to enable the display of the characters to go back, for example to reread a word or a sentence or to slow down the display of the characters. For example, these means allowing acting on scrolling of the characters include a scroll wheel which can be manipulated by one of the thumbs, indeed thumbs are not used in Braille reading. The scroll wheel may be a mechanical scroll wheel. Alternatively, it may be a tactile cursor.

According to this other example of operation of the haptic device, the haptic “display” of a character, more particularly of its dots, is sequential, i.e. the haptic return of the dots 1, 4 and 5 of the Braille character are played shifted over time in an ascending order, i.e. the dot 1 before the dot 4 itself before the dot 5.

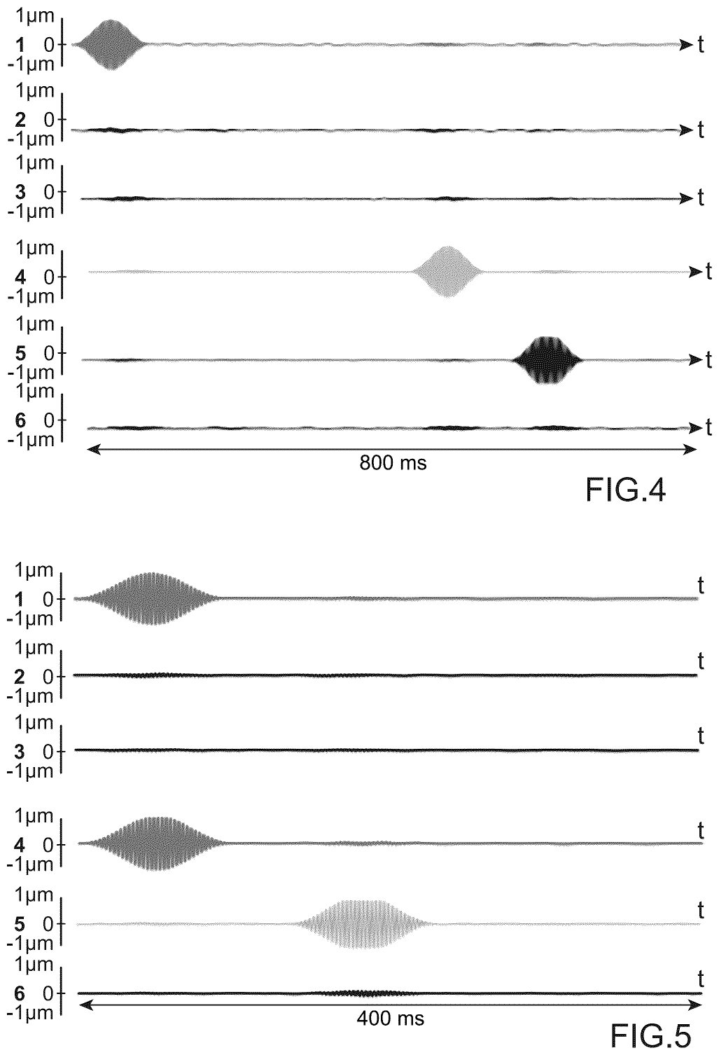

In FIG. 4, one could see the graphical representation of the amplitude of the vibrations over time at the areas Z1, Z4 and Z5. The vibrations appear at different time points in the different areas, the vibration of the area Z1 taking place before that of the area Z4 which takes place before that of the area Z5. The vibration of one area is completed when the vibration of the next area occurs. Enough time between the stimulations of two successive fingers is provided to for enable the user to decode the information. In the illustrated example, the stimulation time is in the range of 200 ms and the time interval between two activated points is 200 ms. These times are indicative and the user will be free to change them at any time.

In the illustrated example, the amplitude of the vibrations is in the range of 1 μm and the duration of the stimulation is in the range of 200 ms.

Advantageously, the duration of the pulses and/or the time between two pulses and/or the amplitude of the stimulations may be adjusted by the user according to their habits and needs, for example during the first use of the device.

According to another example of operation of the haptic device, the dots of a character are played in pairs. For example, the dots 1 and 4 are played at first, then the dots 2 and 5 and finally the dots 3 and 6. It should be understood that either one or none of the dots of each pair is or are translated by a vibration.

In the case of the letter d, as shown in FIG. 5, the areas Z1 and Z4 are excited simultaneously, then only the area Z5 and finally neither the area Z3 nor the area Z6 are excited.

In the illustrated example, the amplitude of the vibrations is in the range of 1 μm and the duration of the stimulation is in the range of 200 ms.

In the above-described reading examples, all areas are excited with the same amplitude, for the same duration and with the same frequency. Alternatively, the areas are excited with different amplitudes and/or for different durations and/or with different frequencies. It may be considered to excite fingers with different frequencies to assist in letter recognition.

Quite advantageously, the haptic device also enables character entry by the user, the device then operating in reading and in writing.

For this purpose, the device includes means for measuring a pressure 10 exerted by each of the six fingers on the touch surface, the control unit 6 having located the location of each of the fingers may deduce from the measurement of the pressures in the six areas which character to “write”. For example, the means 10 for detecting the presence of the fingers on the touch surface are further configured to measure the pressure exerted by a finger, and possibly include the means for measuring the pressure exerted by each finger on the surface. Preferably, the control unit 6 compares the pressure value exerted by each of the fingers to a threshold value below which it is considered that it is not a pressure exerted to generate a Braille character. Thus, the user can permanently leave his/her fingers in contact with the surface without risking this contact being considered as a press to generate a dot of a Braille character.

According to one example, the measurement of the pressure may be carried out by means of force sensors, such as strain gauges, arranged at the periphery of the surface. The total force applied on the surface is then measured, as described in the document U.S. Pat. No. 5,241,308 which describes a touch panel including strain gauges at its four corners, which allows detecting the pressing force at four corners and finding the touched position and the corresponding force. According to another example, the local deformation of the touch surface is measured by means of a grid of electrodes located under the plate opposite the surface through a capacitive measurement. Such an electrode grid is described in the documents U.S. Pat. Nos. 9,349,552 and 5,510,813 for position detection and force detection by capacitive measurement. Still alternatively, it is possible to implement a set of force sensors distributed beneath the surface for position and force multicontact detection, as described in the document. US 2010/0053116 A1.

The order of magnitude of the maximum pressure exerted by the user in Braille writing is in the range of 1 N.

To overcome the problems of hand drift as well as for unintentional keystrokes, algorithms have been developed; such software is described for example in Shiri, WOBBROCK, Jacob O., PRASAIN, Sanjana, et al. Input finger detection for nonvisual touch screen text entry in Perkinput. In: Proceedings of graphics interface 2012. 2012. p. 121-129.

The switch from the reading mode into the writing mode and vice versa may be controlled by a specific gesture on the screen. For example, the user draws a half-circle on the screen with two fingers, showing a roulette-type menu. The user repeats the movement until the “Braille entry” or “Braille reading” entry is read by a speech synthesis and selects Braille entry or Braille reading.

Entry may have several operating modes like for reading. The user can exert presses on all dots of a character simultaneously, successively or in groups.

The areas are then no longer areas for emitting a vibration but areas for capturing signals emitted by one or more finger(s).

The present invention may then be easily integrated into mobile devices such as mobile phones such as smartphones or tablets but also into home automation devices, for example cooktops and other household appliances.

What is claimed is:

1. A haptic device for reading using the Braille-Perkins method including a plate provided with a surface with which at least the index finger, the middle finger and the ring finger of each hand of the user are intended to come into contact, actuators fastened to the plate opposite said surface, said actuators being capable of generating a vibration at the surface in distinct areas, a control unit for controlling said actuators, comprising means for computing the control signals implementing an inverse filtering operation, and configured to send control signals to the actuators, the control unit being configured to make n areas of the surface vibrate, n being an integer comprised between 1 and 6, to stimulate the index finger, the middle finger and the ring finger of each hand of the user and reproduce by haptic stimulation the Braille characters using the Braille-Perkins method, each area corresponding to a dot of a Braille character.

2. The haptic reading device according to claim 1, wherein the control unit is configured to make the n areas vibrate simultaneously.

3. The haptic reading device according to claim 1, wherein the control unit is configured to make the n areas vibrate successively.

4. The haptic reading device according to claim 1, including means for detecting the presence of the index finger, the middle finger and the ring finger of each hand of the user and wherein the control unit is configured to locate the position of the index finger, the middle finger and the ring finger of each hand of the user on the surface and record said positions.

5. The haptic reading device according to claim 1, wherein the detection means include means for measuring the pressure exerted by each finger on the surface.

6. The haptic reading device according to claim 1, including means for controlling the display of the characters on the surface.

7. A haptic device for displaying and entering Braille characters using the Braille-Perkins method including a haptic reading device according to claim 1, wherein the control unit is also configured to translate a measurement of the pressure exerted for each finger at a dot of a Braille character and to identify the Braille character.

8. A method for operating a haptic device for reading digital content given by a user according to claim 1, including:
a) placing at least the index finger, the middle finger and the ring finger of each hand of the user on the surface of the device,
b) translating the digital content into Braille characters,
c) generating for each Braille character signals to the actuators so they make n areas of the surface vibrate, said areas being covered by the index finger, the middle finger and the ring finger of each hand of the user.

9. The operating method according to claim 8, including between step a) and step b), a step of locating the location of the index finger, the middle finger and the ring finger of each hand of the user on the surface and of associating each of these fingers with said location.

10. A method for operating a haptic device for displaying and entering Braille characters using the Braille-Perkins method according to claim 7, implementing steps of:
a) placing at least the index finger, the middle finger and the ring finger of each hand of the user on the surface of the device,
b) translating the digital content into Braille characters,
c) generating for each Braille character signals to the actuators so they make n areas of the surface vibrate, said areas being covered by the index finger, the middle finger and the ring finger of each hand of the user,
the method further including:
measuring the pressure exerted by the index finger, the middle finger and the ring finger of each hand,
comparing with a threshold value,
translating the measurements into a dot of a Braille character and identifying the Braille character.
